(19) United States
(12) Patent Application Publication
(10) Pub. No.: US 2020/0361750 A1
(43) Pub. Date: Nov. 19, 2020

(54) LOCKING CAM FOR A LOAD HOOK, AND ATTACHMENT DEVICE COMPRISING SUCH A CAM

(71) Applicant: LACE, Saint-Maur (FR)

(72) Inventors: CHRISTOPHE AUTISSIER, Briantes (FR); GUILLAUME MEYNIEL, Châteauroux (FR); YOANN SCHMIDT, Guerande (FR)

(73) Assignee: LACE, Saint-Maur (FR)

(21) Appl. No.: 16/967,133

(22) PCT Filed: Feb. 13, 2019
(86) PCT No.: PCT/EP2019/053496

§ 371 Date: Aug. 4, 2020

(30) Foreign Application Priority Data
Feb. 14, 2018 (FR) 1851214

(51) Int. Cl. B66C 1/36; F16H 53/02; B66C 1/34; B64D 9/00

(52) U.S. Cl. CPC B66C 1/36; B64D 9/003; B66C 1/34; F16H 53/025

(57) ABSTRACT

A cam (43) for locking and unlocking a hook (10) of a bearing device (100) intended to lift and transport loads, has a central hub (430), at least one arm (431a) arranged radially relative to the central hub and a shaft (435) rotating the central hub, characterised in that a first end of the shaft (425) is connected to a first rotational device (51) and a second end of the shaft is connected to a second rotational device (52). The invention also relates to a bearing device comprising such a cam.

### TECHNICAL FIELD

The present invention belongs to the field of bearing devices for lifting loads, and more particularly relates to a cargo hook.

More particularly, the invention relates to a load hook for helicopter type aircraft.

### STATE OF THE ART

In the context of lifting and transporting loads, it is known to use bearing devices which enable, via slings or other lifting accessories, the suspension of loads to lifting apparatuses such as static or mobile cranes, helicopters and the like. Such devices are commonly referred to as cargo hooks or load-carrying hooks.

The transportation of external loads suspended from a helicopter requires specific bearing devices that must have a compromise between weight, strength, bulk and safety, in accordance with the requirements of air transport.

The cargo hooks generally include a hook that is pivotable between a closed position, the load bearing position, and an open position in which the load can be released from the hook. The cargo hooks are further provided with a pawl which enables locking of the hook in the closed position during the flight. To be able to quickly release the load, one or more electrical unlocking mechanisms may be provided which can be actuated from the helicopter by the crew to release the pawl and allow the hook to adopt the open position. For security, redundancy of the locking mechanisms is preferable and one or more manual release mechanisms may also be contemplated, said mechanisms being able to take the form of a control lever on the cargo hook itself and/or in the form of a manual unlocking system or a hydraulic system which can also be used inside the helicopter.

There are circumstances where the air safety issues require that the load carried by a helicopter and attached to the outside thereof can be immediately released. For example, the loss or a defective decrease in the speed of an engine during the transport of external goods constitutes emergency situations which require the immediate release of such a cargo. On the other hand, the externally attached cargo is generally suspended at a distance below the helicopter, so that the helicopter and its externally connected cargo define a pendulum system, the helicopter acting as a fixed support for such a pendulum system. The oscillations induced in the externally attached cargo can result in significant stresses in the hook and cause it to be unintentionally opened.

In known attachment devices, the hook is connected to a mechanism which enables it to be held in the closed position and the opening thereof. Such mechanisms generally include locking cams that actuate one or more levers that act on a lock with which the hook opens or closes.

For example, the document GB 2513646 describes a bearing device comprising a hook whose opening and closing are ensured by a mechanism comprising a lock, provided with a first end capable of retaining an upper arm of the hook, a lever cooperating with the lock and a locking cam for actuating the lever.

The locking cams of the known bearing devices are generally actuated by a single control and have no safety redundancy for the release of the transported loads.

### PRESENTATION OF THE INVENTION

The main object of the present invention is to overcome the limitations of the prior art and relates to a cam for locking and unlocking a hook of a bearing device intended for lifting and transporting loads, comprising a central hub, at least one arm arranged radially with respect to the central hub and a shaft driving in rotation said central hub. Said cam is characterised in that a first end of the shaft is coupled to a first rotating device and a second end of said shaft is coupled to a second rotating device independent of said first rotating device.

Advantageously, the central hub comprises a projecting portion on which a transmission element integral with the shaft bears, said transmission element communicating with said central hub a rotational movement of the shaft about an axis of the cam.

According to one embodiment, the shaft is a hollow cylindrical shaft and comprises at each of its ends two longitudinal notches which are diametrically opposite each other, each notch defining two radial walls.

Advantageously, a transverse bar is placed in the notches of each end of the shaft so as to drive said shaft in rotation about the axis of the cam when the rotating device coupled to said end is activated.

According to one embodiment, the first rotation device and the second rotation device are solenoids whose axes are substantially coincident with the axis of the cam.

More particularly, each rotation device can be independently activated via an electrical control.

Advantageously, the shaft is biased in position by a tension spring mounted between the transmission element and a rod integral with a frame, and in which the central hub is returned to position by a torsion spring mounted between said central hub and said rod.

The invention also relates to a bearing device for lifting and transporting loads comprising a hook, a housing in which the hook is pivotally mounted, and a latch and release mechanism placed inside the housing and enabling the opening and closing of said hook. This hooking device is noteworthy in that it comprises a cam according to the preceding features, said cam enabling the tilting of a lever of the latch and release mechanism by a rotation of the at least one arm.

Advantageously, the cam further comprises an indicator arm connected to a device comprising a needle visually indicating a locking status of the cam through a window in a housing protecting said cam.

In one embodiment, the cam is coupled to a hydraulic control rotation device and a mechanical control rotation device.

The fundamental concepts of the invention which have just been explained above in their most elementary form, other details and characteristics will emerge more clearly upon reading the following description and with regard to the appended drawings, giving, by way of non-limiting example, an embodiment of a attachment device according to the principles of the invention.

### BRIEF DESCRIPTION OF THE FIGURES

The various figures as well as the elements of the same figure are not necessarily shown on the same scale. In all of the figures, the identical elements bear the same reference mark.

It is thus illustrated by:

FIGS. 1a and 1b: perspective views of the bearing device according to the invention;

FIG. 2: a perspective view of the latch and release mechanism coupled to the hook according to the invention;

FIG. 3: a front view of the hook of the bearing device according to the invention;

FIG. 4: a front view of the lock of the latch and release mechanism of FIG. 2;

FIG. 5: a front view of the lever of the latch and release mechanism of FIG. 2;

FIG. 6: a front view of the locking cam of the latch and release mechanism of FIG. 2;

FIG. 7: a planar view of the latch and release mechanism and the hook of FIG. 2;

FIG. 8: a schematic and partial planar view of the bearing device revealing the latch and release mechanism and the hook in the open position;

FIG. 9: a perspective view of the locking cam coupled to its activation means according to the invention;

FIG. 10: a perspective view along a first side of the locking cam of FIG. 9;

FIG. 11: a perspective view along a second side of the locking cam of FIG. 9;

FIGS. 12a and 12b: planar views of the locking cam in a locked position (12a) and in an unlocked position (12b);

FIGS. 13a and 13b: schematic diagrams of FIGS. 12a and 12b respectively;

FIGS. 14a and 14b: planar views of the locking cam cooperating with an indicator device according to the invention.

### DETAILED DESCRIPTION OF EMBODIMENTS

In the preferred embodiment described below, reference is made to a bearing device mainly intended for the transport of loads per helicopter. This example is in no way exclusive of applications to lifting and transporting loads by other apparatuses.

Such a bearing device is usually connected to a helicopter which comprises at this end attachment means such as, for example, a clevis, bearing or bores. The bearing device then allows the suspension of the load to be transported, via a lifting accessory. It is understood by lifting accessory any component or equipment not connected to the helicopter, making it possible to grip the load, which is placed either between the bearing device of the helicopter and the load, or on the load itself; slings are for example considered as lifting accessories, slinging material, damping elements, ropes, nets, skips, platforms, vehicle lifting equipment; these lifting accessories can also be provided with secondary hooks, connectors such as rings or shackles, and torsional compensators.

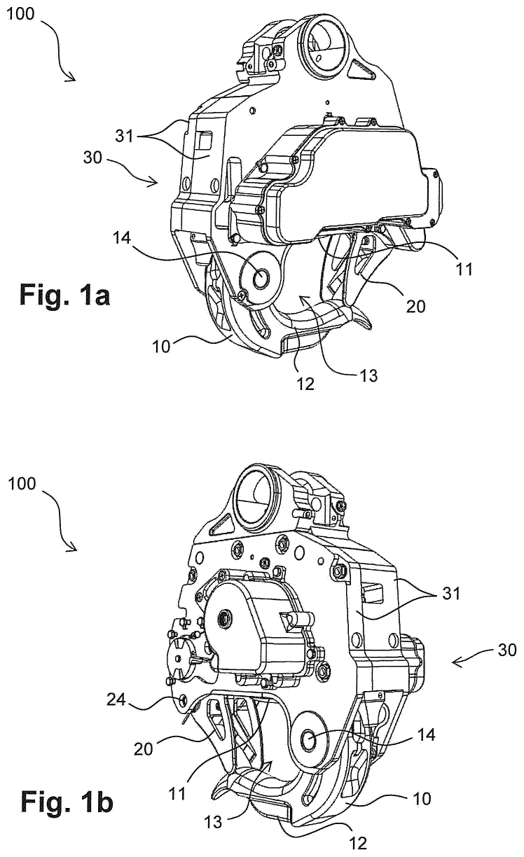

FIGS. 1a and 1b show in perspective views a bearing device 100 comprising mainly a hook 10, a safety pawl 20, a housing 30 with respect to which the hook and the safety pawl are articulated, and in which is placed a mechanism for latching and releasing of the hook which will be described later and which constitutes a fundamental part of the present invention.

According to the example illustrated, the hook 10 has a U-shaped curved shape and comprises an upper arm 11 and a lower arm 12, the load arm, said arms determining a groove 13 in which a connector of a lifting accessory (not shown) is engaged, such as a ring or a shackle.

The hook 10 is mounted so as to pivot relative to the housing 30 about a pivot axis 14 of the hook arranged at a portion joining the two arms of said hook.

FIG. 3 shows the hook 10 isolated from the rest of the bearing device.

According to the example illustrated, the safety pawl 20 comprises two facing planar portions, of generally triangular shape, defining a hollow volume of the pawl, in which volume can be housed a portion of the load arm 12 of the hook 10 with a minimum lateral clearance.

The safety pawl 20 is mounted so as to pivot relative to the housing 30 about a pivot axis of the pawl 24.

The pivot axes of the hook 10 and of the pawl 20 are held stationary with respect to the housing 30.

According to the example illustrated, the housing 30 comprises two flanges 31 spaced apart and connected together by fixing means such as bolts and spacers.

The hook 10 pivots about the pivot axis of the hook 14 between a closed position, a load bearing position, and an open, load-releasing position. In the closed position, the safety pawl 20 closes the open side of the groove 13 of the hook 10 between the end of the upper arm 11 and the end of the load arm 12. The open position in turn corresponds to a clearance of the open side of the groove 13. This clearance is obtained by tilting the hook 10 downwards of the hooking device, the open side of the groove 13 then being separated from the safety pawl 20 which remains substantially at the same position in both configurations, closed and open, of the hooking device.

Furthermore, the safety pawl 20 pivots about the pivot axis of the pawl 24 between an open position and a closed position which can be unlocked or locked, the pawl being constantly biased angularly by a torsion spring (not shown). The operation of the safety pawl is provided by means and components which are not described in the present application, which relates more particularly to the mechanism for unlocking the hook 10.

According to the example illustrated, the latch and release mechanism is placed between the flanges 31, inside the housing 30, and comprises a lock 41, a lever 42 and a locking cam 43.

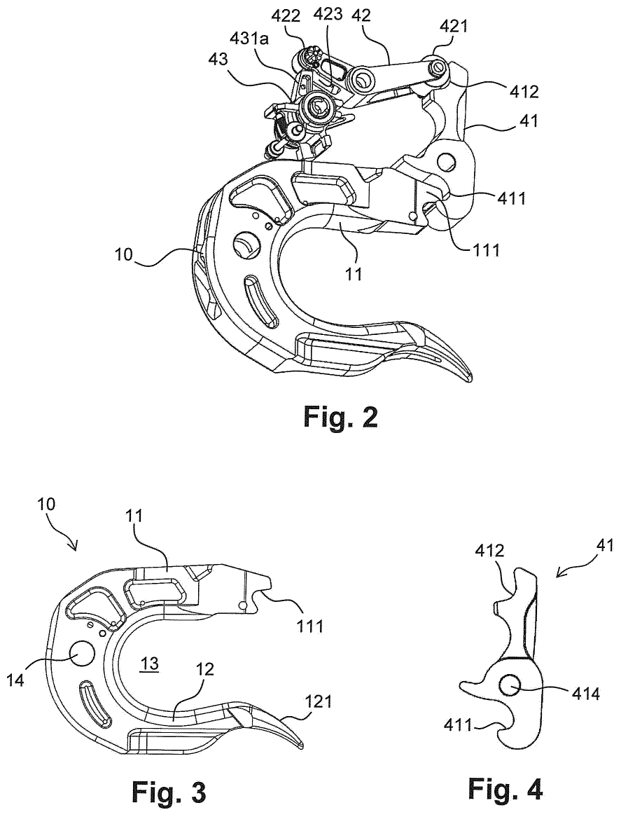

FIG. 2 shows a perspective view of the various elements of the latch and release mechanism of the hook 10, the flanges of FIGS. 1a and 1b being removed to allow the arrangement of elements of said mechanism to be made transparent.

The latch 41, shown in FIG. 4, has an elongated shape and comprises a lower cavity 411 and an upper cavity 412. The latch 41 is pivotally mounted in the housing 30 about a pivot axis 414 of the latch. The two cavities of the latch 41 are provided at both ends of said latch.

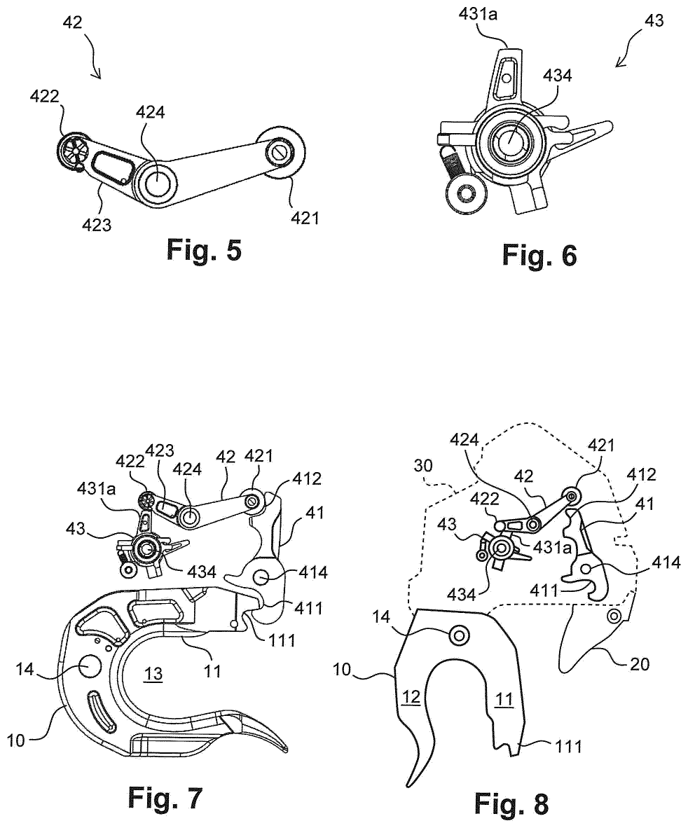

The lever 42, shown in FIG. 5, comprises a first roller 421 at a first end and a second roller 422 at a second end opposite said first end. The lever is mounted so as to pivot in the housing about a pivot axis of the lever, each roller of the lever being able to rotate about a specific axis of the roller, its axis of revolution, for example when the latter is circular.

The locking cam 43, shown in FIG. 6, is pivotally mounted in the housing 30 about a central pivot axis 434, and comprises at least one locking arm 431a.

The latch and release mechanism, comprising the latch 41, the lever 42 and the cam 43, as well as the hook 10 in the closed position are shown in a planar view in FIG. 7 and in perspective view in FIG. 2.

The hook 10 is held in the closed position by means of its upper arm 11 which comprises a bolt 111 at its free end, said bolt being shaped so as to be housed in the lower cavity 411 of the lock 41 and rest on a bearing surface of said lower cavity. In the same closed configuration, the upper cavity 412 of the latch 41 supports the first roller 421 of the lever 42, said upper cavity having a bearing surface adapted to receive the first roller 421 and to the bearing thereof. At the other end of the lever 42, opposite the end comprising the first roller, the second roller 422 rests in stable equilibrium on the locking arm 431a of the locking cam 43. In the closed position, the stable equilibrium of the different elements is maintained by the locking of the locking cam 43 which is then immobilized in rotation about its central pivot axis 434.

The open position of the hook 10 is obtained by unlocking and rotating the locking cam 43, the latch and release mechanism ensuring a transmission of the movement to the hook 10 and producing the downward tilting thereof.

The opening kinematics of the hook 10 from the rotation of the locking cam 43 corresponds, with reference to FIGS. 7 and 8, to a rotation in the clockwise direction of the locking cam which allows the locking arm 431a to drive the rolling of the second roller 422 of the lever 42 until said locking arm is removed in a recess 423 of said lever adjacent to the second roller. The insertion of the locking arm 431a into the recess 423 then releases the rotation of the lever 42 about the pivot axis 424 of the lever, said lever then pivoting in the anticlockwise direction by causing the first roller 421 to roll in the upper cavity 412 of the latch 41. The rolling of the first roller 421, directed upwards, continues until the first roller is released from the upper cavity 412 of the lock 41, the rolling is also maintained by the moment applied to the latch by the action of the hook 10 which tends to pivot the latch counterclockwise. When the lever 42 pivots completely to a predetermined stop, it completely releases the rotation of the latch 41 which then swings by the weight of the hook, and of the load supported thereby, until the bolt 111 of the hook 10 is released of the lower cavity 411 of the said latch, like a trigger system. The hook 10 is then free to tilt downwards by gravity and/or by elasticity.

FIG. 8 shows the latch and release mechanism and the hook in the open position.

Advantageously, the rollers of the lever 42 allow progressive transmission of the movement and of the forces, and thus limit, by virtue of the rolling, any sudden sliding movement of a component that could cause an impact of energy sufficient to damage the component in question and/or its mechanical connections.

According to one embodiment, the lever 42 can be weighted at its second roller or equipped with a spring in order to facilitate its pivoting when the locking cam 43 is rotated.

According to one embodiment, each axis of rotation of a roller of the lever 42 is fixed by means of suitable fastening means such as pins and nuts.

According to one embodiment, the rotation of the locking cam 43 is actuated and controlled by electrical and/or hydraulic controls.

In summary, the closing and opening of the hook 10 are controlled by the locking cam 43, and operated by means of the lever 42, the latch 41 and the load arm 11 having an equilibrium state in which said load arm supports a load and is locked, and an imbalance state in which the load arm releases the load and is unlocked.

The bearing device thus described can withstand a load of 5 kilograms to 10 tons without any risk of untimely opening in case of flight.

The latch and release mechanism coupled to the hook acts as a torque reducer and has an advantageous kinematics that allows the bearing device to support loads varying from five kilograms to ten tons with a locking cam of reduced dimensions that can be activated by reduced forces, and this minimizing the risk of untimely opening of the hook during the flight of the helicopter.

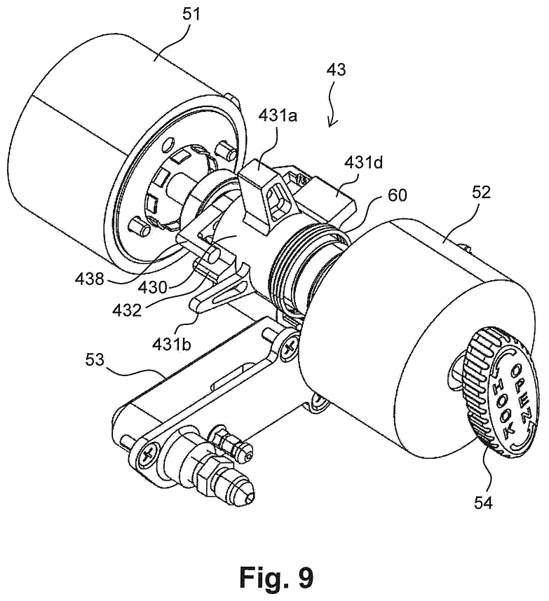

According to the present invention, the locking cam 43 is actuated by four independent means for more secure release of the transported loads. The means for actuating the locking cam are illustrated in FIG. 9 which represents the locking cam 43 coupled to:
a first electric control solenoid 51;
a second electric control solenoid 52;
a hydraulic control system 53;
a mechanical unlocking lever 54.

The first solenoid 51 actuates the locking cam 43 during normal release and can also actuate said cam for emergency release, or safety release, the order of release being provided from the cockpit.

The second solenoid 51 is reserved for emergency release only and is controlled from the cabin by the onboard crew.

The presence of two solenoids for electrically controlling the locking cam 43 indeed makes it possible to dissociate the control of the normal release, provided by the first solenoid 51, of the control of the emergency release, ensured at least by the two solenoids 51 and 52.

The hydraulic control system 53 makes it possible to actuate the locking cam 43 for an emergency release, and can be activated from the cabin via an emergency handle that is not shown.

The mechanical unlocking lever 54 allows a ground crew to unlock the locking cam 43 to open the hook 10 of the hooking device for loading or unloading it.

Apart from the mechanical release lever 54, which can only be handled by a ground operator, the electric control solenoids 51 and 52 of the normal and/or emergency release as well as the hydraulic control system 53 of the emergency release enable the onboard crew to have a significant redundancy in the release commands, which improves the safety of helicopter load transport operations.

For example, the two electrical control solenoids 51 and 52 can be activated simultaneously for more reliability in critical situations such as precision release, and for more power each solenoid may be activated by an independent electrical circuit.

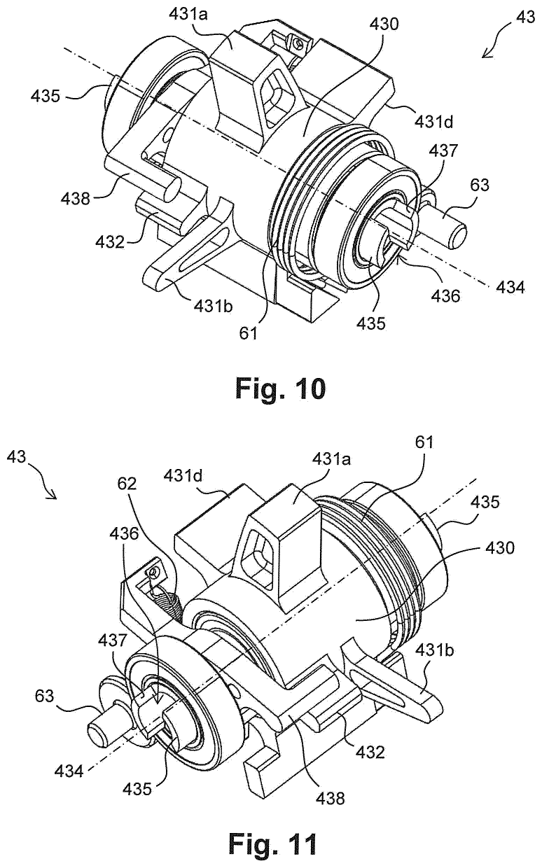

The locking cam 43, according to the embodiment illustrated in FIGS. 10 and 11, comprises mainly a central hub 430 and a hollow cylindrical shaft 435 passing through the central hub and projecting it at its two ends. The hollow shaft 435 is coupled by each of its ends to a solenoid as shown in FIG. 9. Each solenoid induces a rotation of the shaft 435 which in turn drives the central hub 430 thus creating the pivoting movement of the locking cam 43 which is described in more detail below.

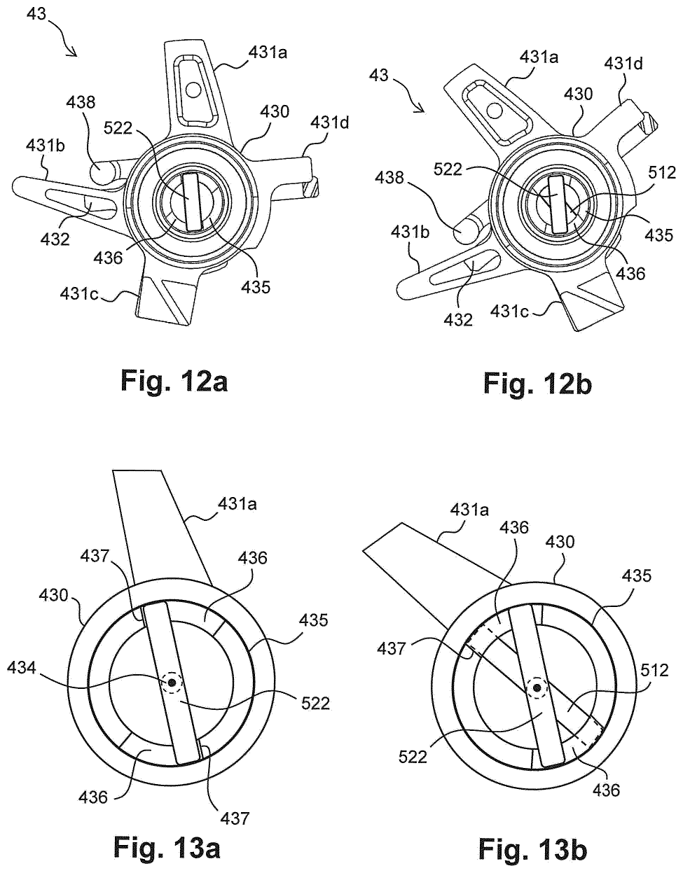

The central hub 430, according to the illustrated embodiment, has a cylindrical body with a circular cross-section, from which the body extends radially from the arms 431a, 431b, 431c and 431d in a configuration as shown in FIGS. 12a and 12b, the locking arm 431a, initially introduced, cooperating with the lever 42 of the latch and release mechanism described above.

The other arms have shapes suitable for performing secondary functions that are not fully explained.

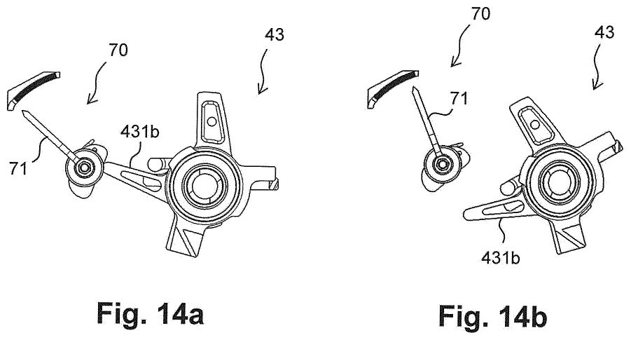

For example, the arm 431b may be connected to an indicator device 70 as shown in FIGS. 14a and 14b comprising a needle 71 which visually indicates the locking status of the locking cam, status directly related to the position thereof, through a window provided in a casing protecting said locking cam.

The central hub 430, according to the example illustrated, further comprises a protruding part 432 on which a transmission part 438 is supported, secured to the hollow shaft 435. The protruding part 432 therefore allows the shaft 435 to rotate, in the direction of the bearing of said transmission part on said protruding part, the central hub 430.

In the exemplary embodiment illustrated, the transmission part 438 is generally U-shaped with a base perpendicular to the shaft 435 and branches parallel to said shaft and offset relative thereto.

The hollow shaft 435, according to the exemplary embodiment illustrated, comprises at each of its ends two notches 436 which are diametrically opposite to each other, extending longitudinally over a determined length. The notches 436 of one end of the hollow shaft 435 are located opposite the notches 436 of the opposite end. Each notch 436 defines two radial walls 437 on the hollow shaft 435.

Each end of the hollow shaft 435 is coupled to an axis of a solenoid via a bar passing transversely through said pin and abutting against the radial walls 437 of the notches 436 of said end.

FIGS. 12a and 12b represent the first bar 512 of the first solenoid and the second bar 522 of the second solenoid inserted transversely into the notches 436 of the hollow shaft 435. Each bar has a length at least equal to the outside diameter of the shaft 435 and is placed diametrically between the two notches 436 of the end of the shaft to which it is coupled. The radial walls 437 of one and the same notch 436 have a gap allowing the bar placed in said notch to have a determined clearance.

An example of operation of the locking cam is schematized in FIGS. 13a and 13b.

FIG. 13a represents the initial state of the locking cam, the second bar 522 and the first bar 512, hidden by said second bar, are each in contact with a first radial wall 437 of a first notch 436 and a second radial wall 437 of the diametrically opposite notch, the two notches 437 being substantially parallel.

When the first electric control solenoid is activated, the first bar 512 is rotated about the axis of the cam 434 in the anticlockwise direction, according to FIGS. 13a and 13b, under the effect of the electromotive force induced by the magnetic field of the first solenoid. The first rod then exerts a torque on the shaft 435 at the level of the radial contact walls 437 producing the rotation of said shaft and of the hub 430 which takes up by its protruding part 432 the movement of the transmission part 438 secured to the shaft 435 as shown in FIGS. 12a and 12b.

According to the invention, the two solenoids 51 and 52 are decoupled and can be activated separately or simultaneously. The examples of FIGS. 12a to 13b illustrate an activation of the first solenoid alone, the second bar 522 therefore remains in its initial position, the rotation of the shaft 435 under the effect of the first bar 512 not affecting the second bar 522 due to the spacing between the radial walls 437 of the notches 436.

Advantageously, this redundancy allows the crew to have two independent activation means, dividing by two the probability of total failure of the activation.

In addition, the torque required to rotate the cam can also be divided by two by simultaneously activating the two solenoids.

In the embodiment illustrated in FIG. 11, the transmission part 432 is connected to a rod 63, secured to the housing of the bearing device, not shown in this figure, by a tension spring 62 that dampens the movement of said transmission part and therefore of the shaft 435, and returns said shaft to its initial position when the action of the solenoids ceases.

The central hub 430 is returned to its initial position, which corresponds to the locking position of the locking cam 43, by means of a torsion spring 61 connecting said central hub to the rod 63 secured to the housing of the coupling device.

1. A cam for locking and unlocking a hook of a bearing device for lifting and transporting loads, comprising a central hub, at least one arm arranged radially with respect to the central hub and a shaft rotatably driving said central hub, characterised in that a first end of the shaft is coupled to a first rotating device and a second end of said shaft is coupled to a second rotating device independent of said first rotating device.

2. Cam according to claim 1, wherein the central hub comprises a protruding part on which a transmission element secured to the shaft is supported, said transmission element communicating with said central hub a rotational movement of the shaft about an axis of the cam.

3. Cam according to claim 1, wherein the shaft is a hollow cylindrical shaft and comprises at each of its ends two notches on respective diameters which are longitudinally opposite to each other each notch defining two radial walls.

4. Cam according to claim 3, in which a transverse bar is placed in the notches of each end of the shaft so as to drive said shaft in rotation about the axis of the cam when at least one of the rotating devices coupled to said end is activated.

5. Cam according to claim 1, in which the first rotation device and the second rotation device are solenoids whose axes are substantially coincident with the axis of the cam.

6. Cam according to claim 1, in which each rotation device can be independently activated via an electrical control.

7. Cam according to claim 1, taken in combination with claim 2, in which the shaft is returned in position by a tension spring mounted between the transmission element and a rod secured to a frame, and in which the central hub is returned to the position by a torsion spring mounted between said central hub and said rod.

8. Bearing device for lifting and transporting loads comprising a hook, a housing in which the hook is pivotally mounted, and a latch and release mechanism placed inside the housing and enabling the opening and closing of said hook, characterised in that it comprises a cam according to claim 1, said cam enabling the tilting of a lever of the latch and release mechanism by a rotation of the at least one arm.

9. Bearing device according to claim 8, wherein the cam further comprises an indicator arm connected to a device comprising a needle visually indicating a locking status of the cam through a window provided in a casing protecting said cam.

10. Bearing device according to claim 8, wherein the cam is coupled to a hydraulic control rotation device and to a mechanical control rotation device.
